(19) United States
(12) Patent Application Publication
(10) Pub. No.: US 2024/0257201 A1
(43) Pub. Date: Aug. 1, 2024

(54) COMMUNICATION THROUGH DIGITALLY RENDERED MATERIALS

(71) Applicant: PPG Industries Ohio, Inc., Cleveland, OH (US)

(72) Inventors: Sabine Julitta Griesbeck, Frankfurt (DE); Rachel Dory Harris, Pittsburgh, PA (US); Ryan Jacob Lutton, Coraopolis, PA (US); Sarat Varma Muppala, Wexford, PA (US); Alison M. Norris, Gibsonia, PA (US); Natalie Meredith Scott, Cleveland, OH (US)

(73) Assignee: PPG Industries Ohio, Inc., Cleveland, OH (US)

(21) Appl. No.: 18/564,045

(22) PCT Filed: May 24, 2022
(86) PCT No.: PCT/US2022/072521

§ 371 Date: Nov. 24, 2023

Related U.S. Application Data
(60) Provisional application No. 63/192,597, filed on May 25, 2021.

(51) Int. Cl. G06Q 30/0601; G06T 11/00; G06T 11/60

(52) U.S. Cl. CPC G06Q 30/0621; G06T 11/001; G06T 11/60; G06T 2200/24

(57) ABSTRACT

A computer system displays a plurality of rendered physical based renders. The computer system also displays a set of user interface elements. Each element in the set of user interface elements is configured to adjust a material attribute associated with the plurality of rendered physical based renders. The computer system receives a command from a user interface element within the set of user interface elements. The command is configured to adjust a specific material attribute. The computer system adjusts the specific material attribute on each physical based render within the plurality of rendered physical based renders.

### TECHNICAL FIELD

The present invention relates to computer-implemented methods and systems for utilizing technological improvements to aid in displaying desired materials.

### BACKGROUND

The modern economy and society are increasingly turning to digital means for communicating both in personal and in business functions. As increasingly more commerce is taking place digitally, it has become more important to provide consumers with the digital tools necessary to fully explore and examine products and services provides by a company. For example, when selling coatings (such as paints), it is useful for customers to be able to accurately view the coatings and to experience the coatings.

In view of the wide-range of different materials, including coating types and colors, it is often challenging for customers to identify a material. For instance, a customer may wish to identify one or more paints for a bedroom or one or more paints for a garden shed. It can be challenging, especially when viewing the color digitally, to appreciate how the coating will look when applied to its intended purpose.

Accordingly, there are several deficiencies within the art that can be benefited by technical advancements. The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed examples include a computer system for dynamically displaying multiple physical based renders. The computer system comprises one or more processors and one or more computer-readable media having stored thereon executable instructions that when executed by the one or more processors configure the computer system to perform various actions. For instance, the computer system may display a plurality of rendered physical based renders. Each physical based render within the plurality of rendered physical based renders is selected based upon a predetermined characteristic that is shared by each physical based render. Additionally, each physical based render depicts a digital representation of a particular material. The computer system also displays a set of user interface elements. Each element in the set of user interface elements is configured to adjust a material attribute associated with the plurality of rendered physical based renders. The computer system receives a command, from a user interface element within the set of user interface elements, the command configured to adjust a specific material attribute. The computer system adjusts the specific material attribute on each physical based render within the plurality of rendered physical based renders.

Disclosed examples also include a computer-implemented method for dynamically displaying multiple physical based renders comprises displaying a plurality of rendered physical based renders. Each physical based render within the plurality of rendered physical based renders is selected based upon a predetermined characteristic that is shared by each physical based render. Additionally, each physical based render depicts a digital representation of a particular material. The computer-implemented method also comprises displaying a set of user interface elements. Each element in the set of user interface elements is configured to adjust a material attribute associated with the plurality of rendered physical based renders. The computer-implemented method further comprises receiving a command, from a user interface element within the set of user interface elements, the command configured to adjust a specific material attribute. Further still, the computer-implemented method comprises adjusting the specific material attribute on each physical based render within the plurality of rendered physical based renders.

Further disclosed embodiments include a computer-storage media comprising one or more physical computer-readable storage media having stored thereon computer-executable instructions that, when executed at a processor, cause a computer system to perform a method for dynamically displaying multiple physical based renders. The method comprises displaying a plurality of rendered physical based renders. Each physical based render within the plurality of rendered physical based renders is selected based upon a predetermined characteristic that is shared by each physical based render. Additionally, each physical based render depicts a digital representation of a particular material. The computer-implemented method also comprises displaying a set of user interface elements. Each element in the set of user interface elements is configured to adjust a material attribute associated with the plurality of rendered physical based renders. The computer-implemented method further comprises receiving a command, from a user interface element within the set of user interface elements, the command configured to adjust a specific material attribute. Further still, the computer-implemented method comprises adjusting the specific material attribute on each physical based render within the plurality of rendered physical based renders.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings, which are described below.

FIG. 1 illustrates a computer system for communicating through digitally rendered materials.

FIG. 2 illustrates a user interface for communicating through digitally rendered materials.

FIG. 3 illustrates another user interface for communicating through digitally rendered materials.

FIG. 4 illustrates another user interface for communicating through digitally rendered materials.

FIG. 5 illustrates another user interface for communicating through digitally rendered materials.

FIG. 6 illustrates another user interface for communicating through digitally rendered materials.

FIG. 7 illustrates a flowchart of a method for communicating through digitally rendered materials.

### DETAILED DESCRIPTION OF THE INVENTION

A computer system for dynamically displaying multiple physical based renders provides an end user with a technically improved system for viewing materials on a display and for extracting useful information from the displayed materials. As used herein, a “material” comprises any physical medium that can be displayed digitally. For example, a material may comprise a coating applied to a digitally rendered surface. The coating may comprise a paint, stain, ink, or other coating substance that impacts the visual appearance of a material. Additionally, the material may comprise only a coating that has not been applied to a particular digitally rendered surface.

The computer system provides innovative and unique systems for displaying multiple physical based renders simultaneously. As used herein, a “swatch” or “material swatch” refer to a physical based render. Additionally, as used herein a “physical based render” refers to a rendering of a material that uses 1) the bidirectional reflectance distribution function (BRDF), or a simplified model of the BRDF, and/or 2) a Bidirectional Texture Function (BTF) to calculate the reflection of light off an opaque surface of the material. In some examples, the BRDF and/or BTF is directly acquired for the digital rendering of the material by performing BRDF and/or BTF measurements on the material in the physical world and then rendering the physical based render using the measurements.

The BRDF comprises:

$${f}_{r} ( {ω}_{i} , {ω}_{r} ) = \frac{d {L}_{r} ( {ω}_{r} )}{d {E}_{i} ( {ω}_{i} )} = \frac{d {L}_{r} ( {ω}_{r} )}{{L}_{i} ( {ω}_{i} ) cos {θ}_{i} d {ω}_{i}}$$

where L is radiance, or power per unit solid-angle-in-the-direction-of-a-ray per unit projected-area-perpendicular-to-the-ray, E is irradiance, or power per unit surface area, and θᵢ is the angle between ωᵢ and the surface normal, n. The BTF is a 6D function whose variables are the 2D position and the viewing and lighting directions. The BTF can be captured via mechanically imaging a surface from multiple different angles under multiple light wavelengths.

The BRDF and/or BTF measurements may be taken using a gonioreflectometer in the physical world. For example, BRDF and/or BTF measurements may be taken of a particular coating on multiple different materials. The different materials may include, but are not limited to, different types of wood, different types of wallboard, different types of metal, different types of plastic, different base coatings (e.g., primer), and various other materials that are commonly coated in industrial, commercial, and residential uses. Each coating-material combination is associated with a unique physical based render. Accordingly, when a physical based render is displayed to an end user, the end user may be able to view a particular coating on multiple different materials.

The computer system may allow an end user to view a group of physical based renders that share a predetermined characteristic. The end user can then manipulate one or more of the physical based renders in ways that change the visual appearance of the one or more physical based renders. Additionally, the end user may manipulate visual aspects of all of the physical based renders simultaneously. Allowing the user to manipulate all of the physical based renders simultaneously may allow a user to compare the impact that the changes have on the multiple physical based renders.

For instance, when displaying complex physical based renders (e.g., swatches with complex coatings, such as automotive coatings with effect pigments), the different manipulations may dramatically impact the visual appearance of the physical based renders in significantly different ways. For example, a user may request to view a particular coating on various different types of primers. In response, the computer system can render multiple physical based renders of the particular coating applied to various different primers. Additionally or alternatively, the user may request to view multiple different coatings within a color family on the same primer. When viewing the physical based renders of the requested material swatches, the end user may be able to visually determine whether one or more colors in the color family are incapable of fully hiding the particular primer.

Additionally or alternatively, the computer system may allow a user to create a digital shadow box, where an end user can add a custom background and manipulate a custom selection of physical based renders. This provides an end user with the ability a visualize different physical based renders in a broad range of custom scenarios and conditions. Such an ability provides significant feedback to designers who rely upon these visualizations to select, manipulate, and create new materials. For example, rendering an architectural coating, in the form of a paint on the exterior of a home, may appear different when viewed with a desert background and associated lighting variables than when viewed with a snow-filled mountain background and the associated lighting variables. The ability to render the material swatches as physical based renders allows the end user to more fully appreciate the impact the environmental lighting has on the material swatch, due at least in part to the use of the BRDF.

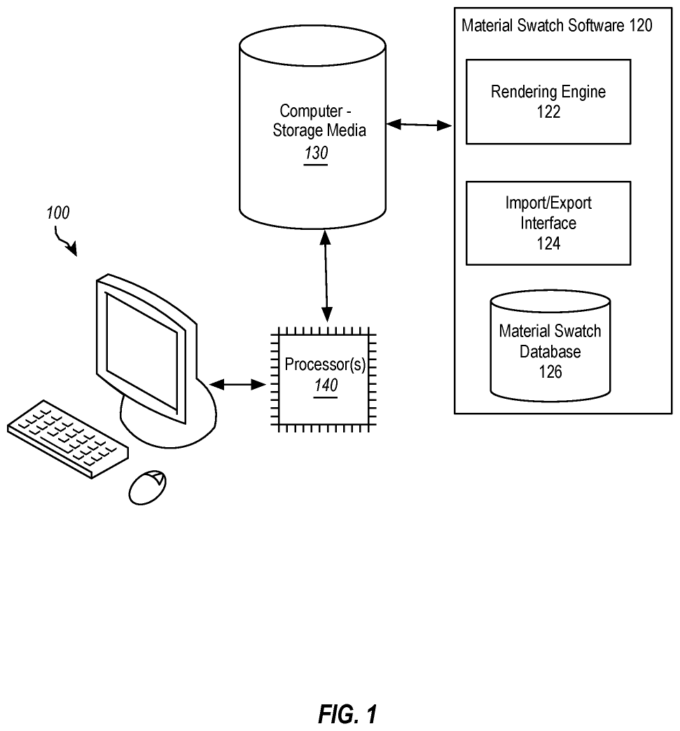

FIG. 1 illustrates a computer system 100 for communicating through digitally rendered materials and dynamically displaying multiple physical based renders. The depicted computer system 100 comprises one or more processor(s) 140 and computer-storage media 130. The computer-storage media 130 comprises executable instructions that when executed by the one or more processors 140 configure the computer system 100 to initiate physical based render software 120. The physical based render software 120 comprises a rendering engine 122, an import/export interface 124, and a physical based render database 126.

As used herein, a “module” comprises computer executable code and/or computer hardware that performs a particular function. One of skill in the art will appreciate that the distinction between different modules is at least in part arbitrary and that modules may be otherwise combined and divided and still remain within the scope of the present disclosure. As such, the description of a component as being a “module” is provided only for the sake of clarity and explanation and should not be interpreted to indicate that any division between functions of computer executable code and/or computer hardware is required, unless expressly stated otherwise. In this description, the terms “component”, “agent”, “manager”, “service”, “engine”, “virtual machine” or the like may also similarly be used.

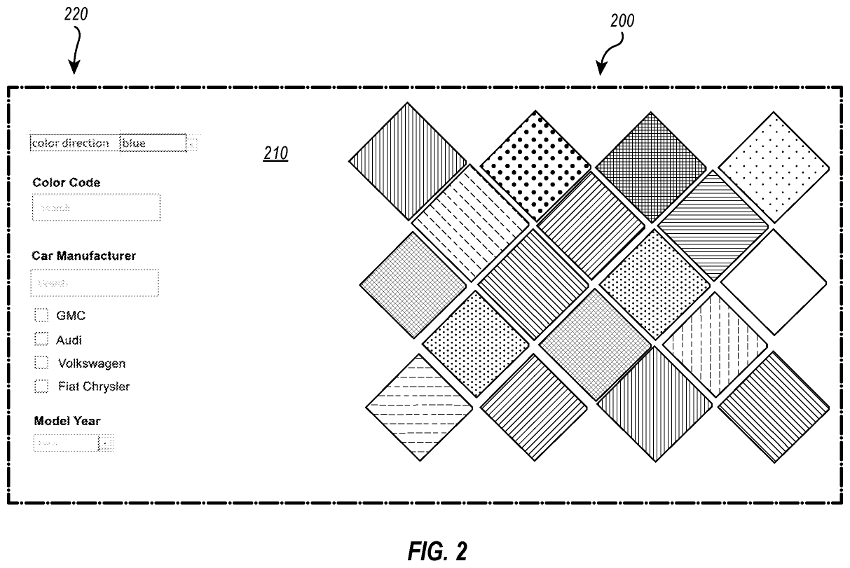

The rendering engine 122 may be configured to display a plurality of rendered physical based renders. For example, FIG. 2 depicts multiple physical based renders 200 within a user interface 210. Each physical based render within the rendered physical based renders 200 is selected based upon a predetermined characteristic that is shared by each physical based render. As used herein, the “predetermined characteristic” refers to a filtering or sorting function that can be applied to physical based renders.

The physical based render database 126, within the physical based render software 120, may comprise thousands of different available physical based renders 200. The physical based renders 200 may be stored as rendered images and/or BRDF data. Additionally, the physical based renders 200 may be stored in a data structure that groups coatings with types of materials that the coating is applied to. For instance, a particular coating may be in the database structure that includes physical based renders of the particular coating applied to a variety of different materials.

As such, the database entry for the physical coating may include metadata that comprise pointers to images of the particular coating on a variety of different materials. In at least one embodiment, the metadata is searchable such that a search function does not need to access image data associated with each physical based render in order to identify which materials the particular coating has been applied to within the available physical based renders. For example, in at least one embodiment, each coating within the database may be relationally linked to datasets that include each of the materials that have physical based renders associated with the coating. As such, a search on an individual coating can quickly indicate each of the materials that can be rendered for that coating.

The physical based renders 200 may each be associated with metadata that describes characteristics of the respective physical based render. By way of example but not limitation, the characteristics may comprise physical based render type, physical based render texture, physical based render cost, physical based render color, tricoat physical based renders, matte or gloss colors on physical based renders, applications for each physical based render, and other similar characteristics. For instance, the physical based renders 200 of interest may be automotive paints. In this example, the predetermined characteristics may comprise color family, model years of automobiles that utilizes each particular physical based render, automobile make, automobile tires or rims, and other automotive related variables. Additionally, the predetermined characteristic may comprise a ‘lead’ color that is representative of very similar colors. In this case, instead of showing many similar colors, only a color lead may be shown or used. An end user can then select a desired lead color in order to see multiple physical based renders 200 that are related to the lead color.

The predetermined characteristic may be defined by the user interface portion 220. Within the user interface portion 220, an end-user is able to select characteristics for a desired set of rendered physical based renders 200. In this example, the predetermined characteristics comprise different colors of automotive coatings applied to virtual panels. As such, each physical based render 200 depicts a digital representation of a particular material—in this case a particular automotive coating applied to a digital panel.

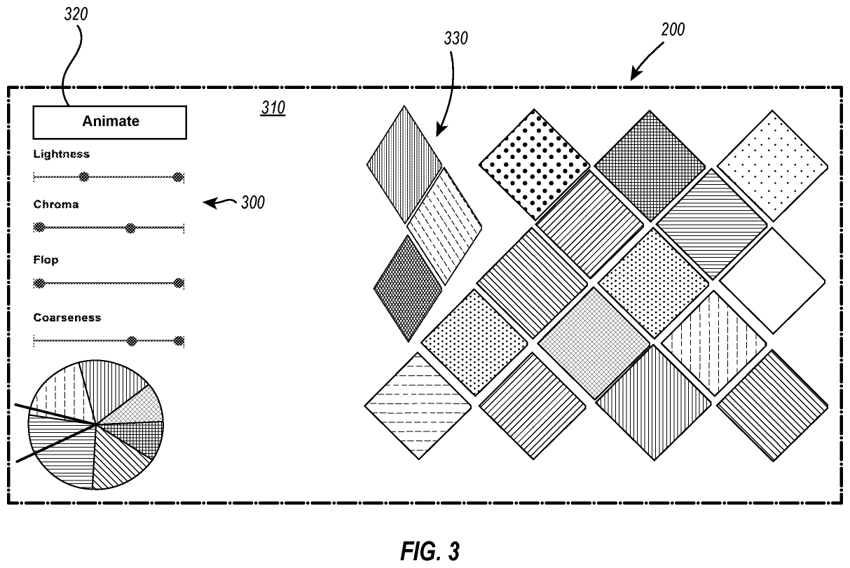

FIG. 3 depicts a user interface 310 that displays a set of user interface elements 300. Each element in the set of user interface elements 300 is configured to adjust a material attribute associated with the plurality of rendered physical based renders 200. In this example, the depicted user interface elements 300 are configured to adjust a lightness, chrome, flop, coarseness, and/or color associated with the physical based renders 200. While the depicted example relates to changes in color, the set of user interface elements 300 may additionally or alternatively be configured to adjust other material attributes. As used herein, “material attributes” include anything that impacts the visual appearance of the physical based renders, including but not limited to, the type of material in the physical based renders 200 (e.g., wood, metal, plastic, fabric, etc.), color attributes applied to the physical based render (e.g., chroma, travel or flop, coarseness or sparkle, etc.), and environmental attribute variables. As used herein, “environmental attribute variables” include aspects such as light sources applied to the physical based renders 200, scenery displayed behind the physical based renders 200, and various other environmental aspects.

With respect to some environmental attribute variables, an end-user may be able to configure the computer system 100 to create a custom environmental attribute variable. For example, an end-user may provide a custom background image for display behind the physical based renders 200. One of skill in the art will appreciate that a background color or image can significantly impact how a color integrated within a physical based render is viewed. For instance, physical based renders of automobile coating may have different visual appearances when viewed against an urban background versus a forest background.

Additionally, in FIG. 3 an end user is provided within an option 320 to animate the physical based renders 200. For example, the rendering engine 122 may be able to rotate or animate at least one based render 330 selected from the plurality of rendered physical based renders 200. In some cases, all of the physical based renders 200 are animated simultaneously. In alternative cases, the rendering engine 122 rotates a first portion of the physical based renders 330 selected from the plurality of rendered physical based renders 200 while a second portion of the physical based renders selected from the plurality of rendered physical based renders 200 remain static. The animation may comprise a simple pre-determined rotation or a user-initiated rotation, such that the user determines the direction of rotation.

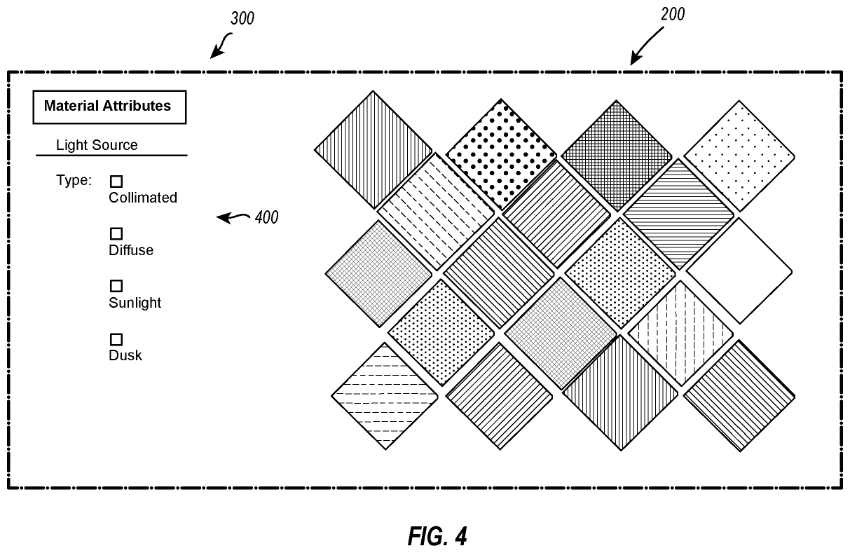

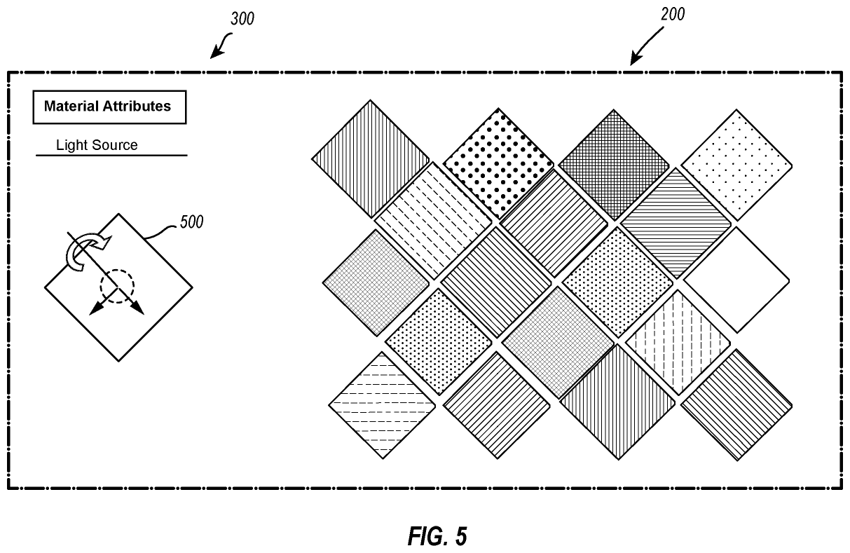

Additionally, an end user may be able to manipulate and/or create custom light sources. For example, FIG. 4 depicts user interface elements 300 that include a light-source-editor element 400. Using these user interface elements 300, an end user may be able to select the number of light sources, the type of light sources (e.g., LED, neon, sunlight, diffuse, dusk, collimated, ambient, etc.), the location of the light sources with respect to each physical based render, and angle of incidence of the light sources with respect to each based render, and various other variables related to the lighting. For example, FIG. 5 depicts user interface elements 300 that include a light-incident-editor element 500. In this example, the light-incident-editor element 500 allows an end user to customize the location of a specular reflection on the surface of a physical based render as well as the incident angle of the light source. When an end user makes a customization to the light source using the light-incident-editor element 500, the rendering engine 122 may re-render all of the physical based renders 200 so that the same lighting variables are applied to each physical based render 200. In this way, each physical based render is independently rendered to include the same environmental attributes of each of the other physical based renders 200. As such, an end user is able to appreciate the impact that changes in lighting have on each individual physical based render in comparison to the other physical based renders. Further, in the case that the end user has displayed the same coating applied to different materials, the end user is able to appreciate the impact of changes in lighting on the same coating that has been applied to different materials.

Accordingly, the physical based render software 120 can receive a command, from a user interface element within the set of user interface elements 300. The command may be configured to adjust a specific material attribute (e.g., lightness). Upon receiving the command, the physical based render software 120 adjusts the specific material attributes (in this example the light) on each based render within the plurality of rendered physical based renders 200. For example, adjusting the lightness causes the rendering engine 122 to re-render all of the physical based renders 200 with the user-provided lightness adjustment.

By adjusting all of the physical based renders simultaneously an end user is able to gain a better appreciation of the effect of the change on each individual based render based upon a greater perception for how the change impacts the other physical based renders. For instance, a given change in lightness may visually impact a particular physical based render more dramatically than the other swatches. By allowing the end user to visually observe the same material attribute change across all of the physical based renders 200 a user is able to perceive that a particular subset of the physical based renders is more significantly impacted by lightness values than another subset of the physical based renders.

Additionally, in some cases, an end user may be able to individually select components that are within a physical based render. For example, the physical based render software 120 may allow an end user to create a particular physical based render that comprises a stack of coatings. For instance, the end user may be able to select individual layers (e.g., e-coat, primer, basecoat, clearcoat, monocoat, etc.). In response, the rendering engine 122 renders the stack of coatings. The stack of coatings may be applied in the order in which the end user selects each individual layer. The resulting physical based render looks like a typical based render, except that the components of the physical based render were custom selected by the end user resulting in a custom color. In at least one embodiment, the render data for the stack of coatings is obtained by using a gonioreflectometer in the physical world to take measurements of each individual layer used in the stack of coatings. The data for each layer can then be combined to create the resulting physical based render.

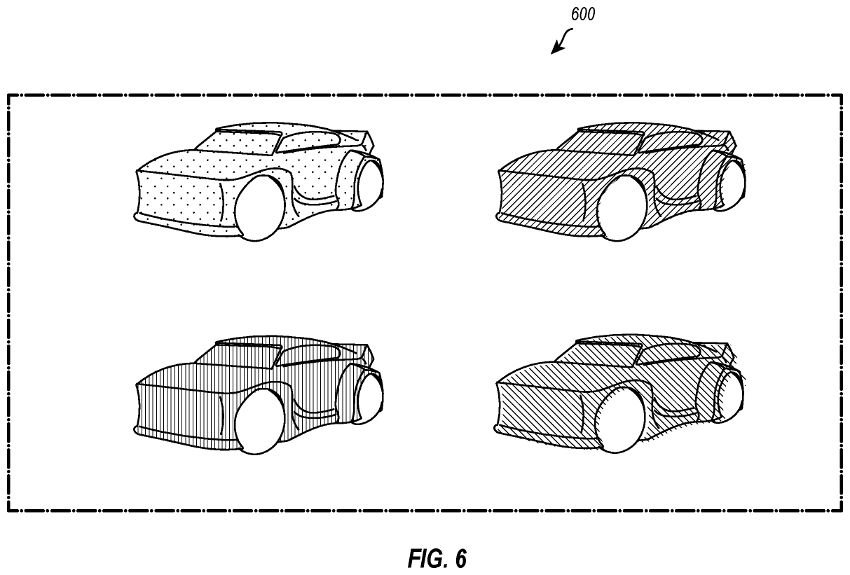

FIG. 6 depicts physical based renders 600 in the form of a car. In this example, each physical based render 600 is displayed as if it were applied to a car and/or the tires or rims. Such a display allows an end user to view the physical based render 600 from the angles that would typically be present on an automobile. Using the tools described above, a user can manipulate the physical based renders 600 to view the impact that each manipulation has on each physical based render.

While FIG. 6 depicts physical based renders 600 in the form of a car, the present application is not so limited. For example, a physical based render 600 may comprise a house, a sign (e.g., a building sign or road sign), a pamphlet, a ship, an airplane, a toy, or any other object that commonly is coated. As described above, each physical based render 600 may account for both the color attributes of a coating and the type of material within the physical based renders 600. Accordingly, an end user may be able to view visually accurate renderings of a business sign, a pamphlet, a toy, a vehicle, or any number of other possible items.

In addition to providing an end user with the ability to visualize and manipulate physical based renders simultaneously, the physical based render software 120 comprises an import/export interface 124 that can communicate a particular request to a material creation server. As used herein, a “material creation server” comprises any computing device that causes a material to be created or provides instructions for a material to be created. For example, the import/export interface 124 may communicate a particular physical based render within the plurality of rendered physical based renders 200 to a formulation device. The formulation device may comprise a coating mixing device or a computer display that display a coating recipe to a human worker who manually mixes the coating. Similarly, the import/export interface 124 may be configurable to generate a report on one or more physical based renders 200 and any customizations the end user made to the material attributes associated with the physical based renders 200. The end user can then save or print the report for later reference.

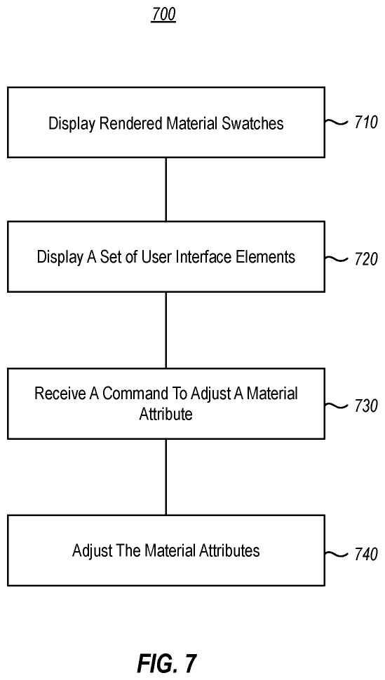

Turning now to FIG. 7, FIG. 7 displays a flowchart for a method 700 for dynamically displaying multiple physical based renders. Method 700 includes an act 710 of displaying rendered physical based renders. Act 710 comprises displaying a plurality of rendered physical based renders 200, wherein: each physical based render within the plurality of rendered physical based renders 200 is selected based upon a predetermined characteristic that is shared by each physical based render, and each physical based render depicts a digital representation of a particular material. For example, FIGS. 2-6 and the accompanying description describe the various displays of physical based renders 200.

Additionally, the method 700 includes an act 720 of displaying a set of user interface elements. Act 720 comprises displaying a set of user interface elements, each element in the set of user interface elements being configured to adjust a material attribute associated with the plurality of rendered physical based renders 200. For example, FIGS. 2-5 and the accompanying description describe interface elements 300 for adjusting material attributes.

In addition, the method 700 includes an act 730 of receiving a command to adjust a material attribute. Act 730 comprises receiving a command, from a user interface element within the set of user interface elements 300, the command configured to adjust a specific material attribute. For example, FIGS. 2-5 and the accompanying description describe adjusts made to material attributes in response to end user inputs.

Further, the method 700 includes an act 740 of adjusting the material attributes. Act 740 comprises adjusting the specific material attribute on each based render within the plurality of rendered physical based renders 200. For example, FIGS. 2-5 and the accompanying description describe adjusts made to material attributes in response to end user inputs.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The invention is further described by the following clauses.

According to a first clause, a computer system for dynamically displaying multiple physical based renders is provided, comprising: one or more processors; and one or more computer-readable media having stored thereon executable instructions that when executed by the one or more processors configure the computer system to perform at least: display a plurality of rendered physical based renders, wherein: each physical based render within the plurality of rendered physical based renders is selected based upon a predetermined characteristic that is shared by each physical based render, and each physical based render depicts a digital representation of a particular material; display a set of user interface elements, each element in the set of user interface elements being configured to adjust a material attribute associated with the plurality of rendered physical based renders; receive a command, from a user interface element within the set of user interface elements, the command configured to adjust a specific material attribute; and adjust the specific material attribute on each physical based render within the plurality of rendered physical based renders.

In a second clause of the computer system of clause one, the predetermined characteristic comprises a shared color family.

In a third clause of the computer system of any one of clauses one or two, wherein the predetermined characteristic comprises a model year of automobiles.

In a fourth clause of the computer system of any one of clauses one to three, wherein the predetermined characteristic comprises a shared make of automobile attribute.

In a fifth clause of the computer system of any one of clauses one to four, wherein the material attribute comprises an environmental attribute variable.

In a sixth clause of the computer system of any one of clauses one to five, wherein the executable instructions include instructions that are executable to configure the computer system to create a custom environmental attribute variable.

In a seventh clause of the computer system of any one of clauses one to six, wherein the material attribute comprises a chroma variable.

In an eighth clause of the computer system of any one of clauses one to seven, wherein the material attribute comprises a travel variable.

In a ninth clause of the computer system of any one of clauses one to eight, wherein the material attribute comprises a coarseness or sparkle variable.

In a tenth clause of the computer system of any one of clauses one to nine, wherein each physical based render comprises a stack of coatings.

In an eleventh clause of computer system of any one of clauses one to ten, wherein the executable instructions include instructions that are executable to configure the computer system to rotate or animate at least one physical based render selected from the plurality of rendered physical based renders.

In a twelfth clause of the computer system of clause eleven, wherein the executable instructions include instructions that are executable to configure the computer system to rotate a first portion of physical based renders selected from the plurality of rendered physical based renders while a second portion of physical based renders selected from the plurality of rendered physical based renders remain static.

In a thirteenth clause of the computer system of clause eleven, wherein the executable instructions include instructions that are executable to configure the computer system to rotate all physical based renders selected from the plurality of rendered physical based renders simultaneously.

In a fourteenth clause of the computer system of any one of clauses one to thirteen, wherein the executable instructions include instructions that are executable to configure the computer system to communicate a particular request to a material creation server.

In a fifteenth clause of the computer system of any one of clauses one to fourteen, wherein the executable instructions include instructions that are executable to configure the computer system to communicate a particular physical based render within the plurality of rendered physical based renders to a formulation device, the formulation device configured to generate a material comprising the particular material.

According to a sixteenth clause, computer-implemented method for dynamically displaying multiple physical based renders, the computer-implemented method executed on one or more computer processors is provided, preferably using the computer system according to any one of clauses one to fifteen, the computer-implemented method comprising: displaying a plurality of rendered physical based renders, wherein: each physical based render within the plurality of rendered physical based renders is selected based upon a predetermined characteristic that is shared by each physical based render, and each physical based render depicts a digital representation of a particular material; displaying a set of user interface elements, each element in the set of user interface elements being configured to adjust a material attribute associated with the plurality of rendered physical based renders; receiving a command, from a user interface element within the set of user interface elements, the command configured to adjust a specific material attribute; and adjusting the specific material attribute on each physical based render within the plurality of rendered physical based renders.

In a seventeenth clause of the computer-implemented method of clause sixteen, wherein the material attribute comprises an environmental attribute variable.

In an eighteenth clause of the computer-implemented method of any one of clauses sixteen or seventeen, further comprising creating a custom environmental attribute variable.

In a nineteenth clause of the computer-implemented method of any one of clauses sixteen or eighteen, further comprising rotating or animating at least one physical based render selected from the plurality of rendered physical based renders.

According to a twentieth clause, a computer-storage media comprising one or more physical computer-readable storage media having stored thereon computer-executable instructions that, when executed at a processor, cause a computer system to perform a method for dynamically displaying multiple physical based renders, is provided, preferably using the computer system according to any one of clauses one to fifteen and/or the method according to any one of clauses sixteen to nineteen, the method comprising: displaying a plurality of rendered physical based renders, wherein: each physical based render within the plurality of rendered physical based renders is selected based upon a predetermined characteristic that is shared by each physical based render, and each physical based render depicts a digital representation of a particular material; displaying a set of user interface elements, each element in the set of user interface elements being configured to adjust a material attribute associated with the plurality of rendered physical based renders; receiving a command, from a user interface element within the set of user interface elements, the command configured to adjust a specific material attribute; and adjusting the specific material attribute on each physical based render within the plurality of rendered physical based renders.

In a twenty-first clause of the computer system, computer-implemented method, and/or the computer-storage media according to any one of clauses one to twenty, wherein the physical based render refers to a rendering of a material that uses 1) the bidirectional reflectance distribution function (BRDF), or a simplified model of the BRDF, and/or 2) a Bidirectional Texture Function (BTF) to calculate the reflection of light off an opaque surface of the material.

In a twenty-second clause of the computer system, computer-implemented method, and/or the computer-storage media according to clauses twenty-one, wherein BRDF and/or BTF measurements are taken using a gonioreflectometer.

In a twenty-third clause of the computer system, computer-implemented method, and/or the computer-storage media according to any one of clauses twenty-one to twenty-two, wherein the BRDF and/or BTF measurements is taken of a particular coating on multiple different materials.

In a twenty-fourth clause of the computer system, computer-implemented method, and/or the computer-storage media according to any one of clauses twenty-one to twenty-three, wherein the render data for a stack of coatings is obtained by using a gonioreflectometer in the physical world to take measurements of each individual layer used in the stack of coatings and the data for each layer can then be combined to create the resulting physical based render

In a twenty-fifth clause of the computer system, computer-implemented method, and/or the computer-storage media according to any one of clauses one to twenty-four, wherein the predetermined characteristics comprise color family, model years of automobiles that utilizes each particular physical based render, automobile make, color and/or automobile tires or rims.

In a twenty-sixth clause of the computer system, computer-implemented method, and/or the computer-storage media according to any one of clauses one to twenty-five, wherein the specific material attribute comprise the lightness, chrome, flop, coarseness, and/or color associated with the physical based renders.

In a twenty-seventh clause of the computer system, computer-implemented method, and/or the computer-storage media according to any one of clauses twenty-one to twenty-six, wherein the BRDF and/or BTF is directly acquired for the digital rendering of the material by performing BRDF and/or BTF measurements on the material in the physical world and then rendering the physical based render using the measurements.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1-20. (canceled)

21. A computer system for dynamically displaying multiple physical based renders, comprising:
one or more processors; and
one or more computer-readable media having stored thereon executable instructions that when executed by the one or more processors configure the computer system to perform at least:
display a plurality of rendered physical based renders, wherein:
each physical based render within the plurality of rendered physical based renders is selected based upon a predetermined characteristic that is shared by each physical based render, and
each physical based render depicts a digital representation of a particular material;
display a set of user interface elements, each element in the set of user interface elements being configured to adjust a material attribute associated with the plurality of rendered physical based renders;
receive a command, from a user interface element within the set of user interface elements, the command configured to adjust a specific material attribute; and
adjust the specific material attribute on each physical based render within the plurality of rendered physical based renders.

22. The computer system of claim 21, wherein the predetermined characteristic comprises a shared color family.

23. The computer system of claim 21, wherein the predetermined characteristic comprises a model year of automobiles.

24. The computer system of claim 21, wherein the predetermined characteristic comprises a shared make of automobile attribute.

25. The computer system of claim 21, wherein the material attribute comprises an environmental attribute variable.

26. The computer system of claim 25, wherein the executable instructions include instructions that are executable to configure the computer system to create a custom environmental attribute variable.

27. The computer system of claim 21, wherein the material attribute comprises a chroma variable.

28. The computer system of claim 21, wherein the material attribute comprises a travel variable.

29. The computer system of claim 21, wherein the material attribute comprises a coarseness or sparkle variable.

30. The computer system of claim 21, wherein each physical based render comprises a stack of coatings.

31. The computer system of claim 21, wherein the executable instructions include instructions that are executable to configure the computer system to rotate or animate at least one physical based render selected from the plurality of rendered physical based renders.

32. The computer system of claim 31, wherein the executable instructions include instructions that are executable to configure the computer system to rotate a first portion of physical based renders selected from the plurality of rendered physical based renders while a second portion of physical based renders selected from the plurality of rendered physical based renders remain static.

33. The computer system of claim 31, wherein the executable instructions include instructions that are executable to configure the computer system to rotate all physical based renders selected from the plurality of rendered physical based renders simultaneously.

34. The computer system of claim 21, wherein the executable instructions include instructions that are executable to configure the computer system to communicate a particular request to a material creation server.

35. The computer system of claim 21, wherein the executable instructions include instructions that are executable to configure the computer system to communicate a particular physical based render within the plurality of rendered physical based renders to a formulation device, the formulation device configured to generate a material comprising the particular material.

36. A computer-implemented method for dynamically displaying multiple physical based renders, the computer-implemented method executed on one or more computer processors, the computer-implemented method comprising:
displaying a plurality of rendered physical based renders, wherein:
each physical based render within the plurality of rendered physical based renders is selected based upon a predetermined characteristic that is shared by each physical based render, and
each physical based render depicts a digital representation of a particular material;
displaying a set of user interface elements, each element in the set of user interface elements being configured to adjust a material attribute associated with the plurality of rendered physical based renders;
receiving a command, from a user interface element within the set of user interface elements, the command configured to adjust a specific material attribute; and
adjusting the specific material attribute on each physical based render within the plurality of rendered physical based renders.

37. The computer-implemented method of claim 36, wherein the material attribute comprises an environmental attribute variable.

38. The computer-implemented method of claim 37, further comprising creating a custom environmental attribute variable.

39. The computer-implemented method of claim 36, further comprising rotating or animating at least one physical based render selected from the plurality of rendered physical based renders.

40. A computer-storage media comprising one or more physical computer-readable storage media having stored thereon computer-executable instructions that, when executed at a processor, cause a computer system to perform a method for dynamically displaying multiple physical based renders, the method comprising:
displaying a plurality of rendered physical based renders, wherein:
each physical based render within the plurality of rendered physical based renders is selected based upon a predetermined characteristic that is shared by each physical based render, and
each physical based render depicts a digital representation of a particular material;
displaying a set of user interface elements, each element in the set of user interface elements being configured to adjust a material attribute associated with the plurality of rendered physical based renders;
receiving a command, from a user interface element within the set of user interface elements, the command configured to adjust a specific material attribute; and
adjusting the specific material attribute on each physical based render within the plurality of rendered physical based renders.
